(19) United States
(12) Patent Application Publication
(10) Pub. No.: US 2017/0136365 A1
(43) Pub. Date: May 18, 2017

(54) VARIABLE SELECTED PLAYER IN FANTASY SPORTS WAGERING EVENT WITH SALARY CAP

(71) Applicant: Jeffery J. Hwang, Henderson, NV (US)

(72) Inventor: Jeffery J. Hwang, Henderson, NV (US)

(21) Appl. No.: 14/939,952

(22) Filed: Nov. 12, 2015

(51) Int. Cl. A63F 13/828; G07F 17/32; A63F 13/30; G07F 17/34

(52) U.S. Cl. CPC A63F 13/828; G07F 17/34; G07F 17/3244; G07F 17/323; G07F 17/3211; A63F 13/30

(57) ABSTRACT

A method of and apparatus executes a wagering event and resolving a wager. A processor stores a list of game players generally within a field of a single sport. The processor provides at least one first set of multiple game players, each game player in the set provided with a salary value. The processor allows a salary cap to each event player for selecting one list for the event player. The processor accepts a wager from the event player on one list of game players selected by input of the player to the processor from set of multiple game players lists. The total number of game players selected in the one list is limited solely by exhaustion of the salary cap by totaling salary values for all event players selected by input of the event player, independent of numbers of total game players selected. The wager is based on an outcome within a predetermined period of time and is resolved by determination of odds against a paytable of whether total game points from the one list exceed total game points scored by the at least second list or exceed the fixed number of game points.

### BACKGROUND OF THE INVENTION

1. Field of the Invention

The present technology relates to the field of wagering, particularly wagering in which outcomes are based upon sports event outcomes, and in particular to the type of wagering known as fantasy sports wagering, such as fantasy football or fantasy basketball.

2. Background of the Art

Fantasy Football and other Fantasy Sports competitions are interactive competitions in which users compete against each other as general managers of virtual teams built from real players. In Fantasy Football, for example, the players that an individual is able to manage are professional American Football players in the National Football League. The different actions people are able to make are drafting, trading, adding or dropping players, and changing rosters. Due to the growth of the Internet, fantasy football has vastly increased in popularity, particularly because fantasy football providers such as ESPN, Yahoo, CBS, and the NFL itself are able to keep track of statistics entirely online, eliminating the need to check box scores in newspapers regularly to keep track of players. Most leagues have a single week championship in week 16 of the NFL season.

The rules for what eventually became fantasy football were developed starting in 1963 at New York City's Milford Plaza Hotel by a limited partner in the Oakland Raiders named Wilfred “Bill” Winkenbach together with Bill Tunnell, former Raiders public relations manager, and Scotty Stirling, a former reporter.

There are several different types of fantasy football leagues. The two most popular types are: head-to-head and total points leagues. Type of league is the first category in which a manager must designate to participate.

In head-to-head leagues, a team matches up versus a different team each week. The team who receives the most points of the two receives a win for that particular week. Points are dictated by the scoring system that is either standard set by the website or custom set by the commissioner. A team's total is the sum of all players points in the starting lineup. The win-loss record is the most important statistic in head-to-head leagues, as it directly correlates with the league champion. Teams with the best win-loss record advance to the playoffs. If two teams have the same record, the tie-breaker is then decided by the total points scored in the regular season of the two (or more) tied teams. Further tie-breakers can be added based on league preference.

Total points leagues are leagues in which teams accumulate points on an ongoing basis. The league standings are determined by the teams' total points rather than their win-loss record. The teams who accrue the highest total of points throughout the duration of the NFL-regular season advance to the playoffs.

A Keeper style fantasy football league allows teams to keep players from one year to the next. Traditionally, league rules dictate the number of players that can be kept from year to year, as well as the ‘penalty’ for keeping a player. The standard ‘penalty’ for keeping a player is the forfeiture of a draft pick two rounds earlier than the player was selected (ex. a team would lose a 4th round pick if the player they are keeping was drafted in the 6th round. Furthermore, if this player is kept the following year, the team would forfeit a 2nd round pick).

A dynasty “Keeper” style fantasy football league is a league where you retain most or all of your players from year to year. This creates an environment which is very different from that of a redraft league. In such leagues, the type of players available in the yearly draft is focused more towards rookies with long-term potential.

The salary cap football league is a particular type of dynasty league which adds another factor of realism similar to the NFL: the salary cap. Just like in the NFL, this means each player has an associated salary and the total spent on all the players on a team has a maximum—the “salary cap.” This can have many levels of complexity, e.g. a player may be signed for multiple years, etc.

GMs nominate players (in order) to be bid on by all GMs in the league. Each franchise has a cap (standard is $200) that they can spend on their entire roster. This is the fastest growing format of fantasy football. There are websites and podcasts devoted to this specific method of playing fantasy football. The first website and podcast dedicated to this type of fantasy football is the Fantasy Football Auctioneer.

Points-Per-Reception (or PPR) leagues were created as an effort to make Wide Receivers and Tight Ends more relevant to fantasy scoring. In this alternate scoring system, fractional or full points are awarded for every reception tallied by a player. This changes the value of players in typical fantasy football scoring, as running backs who catch many passes become more valuable, those who catch fewer are less valuable, and so on.

Two Quarterback leagues, similar to Points-Per-Reception leagues, were created as an effort to make Quarterbacks more relevant to fantasy scoring. In this alternate scoring system, a team has the ability to start 2 quarterbacks in their weekly lineup. This changes the value of the Quarterback position, as it doubles the number of Quarterbacks able to start in any given week. It also reduces the depth of available players, making the position more important for effective roster building.

Daily fantasy sports is like traditional fantasy sports where players draft a team of real world athletes who then score fantasy points according to set scoring rules. However, instead of being stuck with the same team through a whole season, daily fantasy sports contests last just one day (or in the case of NFL, one weekend). Users can play head-to-head or in larger field tournaments. Cash leagues as well as free contests are available for play.

Several websites, including NFL.com, offer a fantasy football league during the NFL's playoffs. Participants choose players from several different positions and receive points each week for their performances. The league lasts until the Super Bowl. Players who are on a fantasy roster for consecutive weeks earn double, triple, and finally quadruple points.^{[8]} Scoring is usually the same as in most season-long leagues.

A new style of fantasy football is modeled after the popular “survivor pool” or “knock out pool” style of weekly NFL wagering that allows each pool member to pick one NFL team to win each week, but he or she can only pick that team once all year.

Similarly, survivor fantasy leagues allow owners to draft a fresh team of seven players each week, with each player only available to each owner one week per year. This added level of strategy places an emphasis on weekly NFL match ups, while at the same time diminishing the negative consequences of injuries.

Another type of league that allows for year round fantasy football is called Simulation Football. Simulation Football uses a computer to simulate the games with simulated players, instead of relying on the NFL for its players and stats. The most basic type is a GM league, where all the player has to do is put together a team and the computer does most of the work. A much more involved type of simulation football is called a “Create-a-Player” or CAP league. In a CAP league, top players vie for the chance to be a GM and put together a team using players that are created by other people. There are different types of scoring for determining who is a “top player” but the people are charged with making their player as good as possible using the league's scoring system.

The popularity of fantasy football has filtered down into the collegiate level as well. Fantasy College Football is gaining in popularity as diehard fantasy players and college football fanatics combine two of their favorite passions into one. The most popular leagues involve the BCS only schools while other leagues incorporate all FBS schools or even just the “non-BCS” schools.

The Draft—Just like in real football, each year fantasy football leagues have a draft (note: in dynasty leagues, this normally consists of NFL rookies only), in which each team drafts NFL players. These players are kept unless they are traded or dropped, whereby they enter a pool of unowned players that any team may claim. In most leagues, no player may be owned by more than one team, although some leagues do allow for this.

There are essentially two types of drafts. In a traditional “serpentine” or “snake” draft, owners take turns drafting players in a “serpentine” method, i.e. the owner who picks 1st in the odd rounds picks last in the even rounds, in the interests of fairness.

In an auction draft, each owner has an imaginary budget which he must use to purchase all his players in an auction format. Owners take turns nominating players for open bid. The owner who bids the highest on each player receives that player, reducing their remaining budget accordingly. Auction drafts are viewed as the more fair method since every owner begins on equal ground.^{[9]} A few leagues use a hybrid of the two styles, selecting a portion of their roster via auction, with the remainder selected through a serpentine method.

As the NFL has evolved, so have fantasy football draft strategies.^{[10]} The most commonly used strategies are value based drafting and opinion based drafting. Value base drafting entails projecting the total fantasy point value for each player in the draft and then figuring their value with respect to other players at their position, while standard cheat sheet based drafting requires ranking each player based on your opinion of worth, or other people's opinion of said player's worth.

Drafts can be conducted in “live” or “auto” formats. Live drafts involve players utilizing real-time strategy and reactionary measures to acquire specific available players. Auto-drafts use preliminary draft rankings set by each team to automate the draft cycle and establish the teams. Live drafts are often preferred to automated as they are believed to require more skill.

The location of fantasy football drafts depend on the geographic location of each team manager. With the rise of the internet, all Fantasy football providers have made online drafting an option for leagues in which the managers are too far away to meet up in person. Other leagues make a tradition of meeting up to draft, and in some leagues, managers travel cross-country to attend annual league drafts. Group drafts conducted in-person are typically scheduled many weeks in advance. Common locations include boardrooms, offices, bars, or dining establishments.

Each owner assigns his/her team a name, which can be based on anything. Some names are based on the owner's life or personality, while many are based on current events or a pun or word play using the name of a favorite player. Choosing an especially clever or funny team name can win an owner accolades from other owners including digital league trophies for the best name, and sports writers who cover fantasy football often compile their own lists of their favorite fantasy football team names from a given year.

Free agents and trades are important components to maintaining a competitive roster throughout the duration of a season. Free agents exist in fantasy leagues that do not allow multiple teams to have any one professional athlete. In these leagues, free agents are professional players that are not currently on any league member's roster. You can add, or claim, players anytime during the season.

Some leagues do not allow you to drop high profile players who may not be performing well (in fantasy scoring terms). This can be very challenging as an owner's only option to get this player off their team is to find another owner who is willing to make a trade for the under performing player.

At the beginning of every week, after the Monday night football game, team owners can claim free agents. The waiver claims are processed later on in the week. If more than one team owner claims a player, a team's waiver wire position determines who gets the player. A team's waiver wire ranking is determined by things like team record and the number of free agents already added. The worse a team's ranking, the more likely they will get the best free agents. This helps competitiveness as the season wears on. Usually there are several surprise players that are not drafted by any team and yet become some of the best fantasy players.

Some leagues have trade deadlines that are set, and others have a waiver period before free agents can be picked up. This really depends as to how the league is set up. When a trade is proposed and accepted in some leagues there can be a voting period which will allow the league to decide if the trade is acceptable or not, while other leagues have a period in which the league manager can decide to veto the trade.

Often within fantasy football leagues trades are made that cause controversy and are considered unfair by many other members of the league. These disputes are sometimes settled by fantasy football trade referees. These third party sites feature experienced fantasy players who rule on trades and offer an objective third party opinion.

Players may not need to use trade referees if the league uses the voting system in which the league can approve or decline the trade that has been placed. In some leagues if there is a voting period and a trade referee in place, the trade referee can overrule the league voting and this can cause controversy as well. Other leagues give their league manager the power to veto or pass the trade.

Team Roster—Each team is allowed a pre-determined number of players on its team, as well as a specified number at each position that can or must be used in each game (the “starters”). Owners for each team then determine each week which players will start (within the rules) and which will be “benched”. Just like in real football, bench players can become starters for various reasons: due to other players' injury, poor performance, or if another player's team has a bye.

Each week, owners choose their starters for a game before a certain deadline. Whether to sit or start a player is usually based on strategic considerations including the player's past and expected performance, defensive match ups, and so on.

Starters—Each team owner must designate which players from the team roster will be starters each week—i.e. the only players who will “score” any points. The following example is similar to many common formats required for a starting lineup:
1 Quarterback (QB)
2 Running Backs (RB)
2 Wide receivers (WR)
1 Flex RB/WR/TEs (RB/WR/TE)
1 Tight End (TE)
1 Placekicker (K)
1 Team Defense/Special Teams (D/ST)
6 Bench (BN)

There are many variants on this. Some leagues use individual defensive players (IDPs) (and in some cases a punter) instead of or in addition to a combined Team Defense/Special Teams. Some other leagues use separate Defense and Special Teams. Another variant is the “flex” position, which can be filled by a player in one of several positions. Flex positions are often limited to “WR/TE”, “RB/WR”, or “RB/WR/TE”. Traditionally, this flex was required to be an RB, WR, or TE; however, some leagues allow any position to fill this flex slot as an “OP” (any Offensive Player). Some leagues also have a two-quarterback requirement for a starting lineup, providing yet another twist into the complexity of different scoring systems and lineups (Hendricks, 2007 Fantasy Football Guidebook pg. 21-44).

Scoring—Players earn their team points based on their performance in their weekly games; for example, each touchdown counts as 6 points, a certain number of yards gained counts for points, and so on. In almost all cases, players earn points for passing, rushing, and receiving yards. Passing yards (sometimes touchdowns as well) typically earn about half as many points as rushing/receiving yards, since QBs normally get many more. Negative points are also usually given for turnovers, and kickers earn points for field goals and extra points (sometimes negative points for missed kicks). Bonuses can also be given for exceptionally good performances, like a QB throwing for over 300 yards, or a kicker making a long field goal. Team defenses earn points for things like sacks, turnovers, safeties, etc. Individual defensive players typically do not earn points for team-wide stats such as keeping the opponent under a certain score or yardage total, but rather for tackles or turnovers made.

A typical scoring format follows. Again, there are many variations used:
1 point for 25 passing yards
1 point for 10 rushing yards
1 point for 10 receiving yards
1 point for a reception
6 points for a touchdown
4 points for a passing touchdown
−2 points for every interception thrown or fumble lost
1 point for each extra point made
3 points for each 0-39 yard field goal, 4 points for each 40-49 yard field goal, and 5 points for each 50+ yard field goal
2 points per turnover gained by defense
1 points per sack by the defense
2 points for a safety by defense
6 points for each touchdown scored by defense
2 points for each blocked kick

An alternate scoring format is the “pure yardage” league, in which touchdowns are ignored, and each player's passing, rushing and receiving yards are totaled. Some yardage leagues also convert defensive stats into yards (ex., 50 yards for an interception, 20 yards for a sack), whether for a team's defense, or individual players. Another scoring system counts only touchdowns, touchdown passes, and field goals for points. Many leagues also count points per reception (PPR). In PPR leagues your team scores points for every reception made by a player, usually a TE, RB and WR.

An alternative method for scoring defense is Individual Defensive Players or IDP fantasy football. The main difference being that players typically draft anywhere from 3 to 7 individual defensive players during a draft as opposed to just one team defense. Sometimes there are required positions to fill like 2 Linebackers, 2 Defensive Backs and 2 Defensive Linemen and sometimes it's just 5 defensive players of any position you choose. There are many different ways to draft IDPs and many have found this makes the later part of the fantasy draft more exciting. For instance, instead of drafting a 5th wide receiver in the 16th round that will typically be on your bench or dropped part way through the season, you are instead drafting a “full-time” starting defensive player that can help you win your league.

Many leagues are composed of friends, family, co-workers and even strangers that are in the fantasy league to prove who is the greatest couch coach. Millions upon millions of dollars are won and lost each year in fantasy league betting. The Federal government has determined that fantasy league gambling is not a “game of chance” and as such is not illegal. Websites such as FantasyHook.com and Leaguesafe.com make fantasy fee transactions simple by completely automating the buy in and the payout of the winnings.

There are a few dynasty leagues that follow the NFL's roster model and score all possible NFL players at all individual positions. Offensive linemen (OL) are scored by total yards and points minus sacks given up. Fullbacks are partially scored as offensive linemen because of their blocking duties. Kick and punt returners are scored by yardage and touchdowns. Punters are scored by net average and punts inside the 20 yard line.

The way a fantasy owner watches a game is greatly affected if a player on their team is playing. An owner will root for specific things to happen in order for their player(s) to score points. For example, someone who has a running back will root for a goal line situation or for the team the running back plays for to be up by a significant amount of points. If the running back's team is on the goal line, then a running play is more likely to be called. If the running back's team is up by a significant amount of points, his team will call more running plays in order to run out the clock. The more running plays called, the more points for that running back. Different scenarios will provide certain players an opportunity to score points for fantasy owners.

The game is quite complex and intimidating to new players, especially with respect to ultimate scoring, trading, and purchasing of players. This complexity has also made use of Fantasy Football in a gaming environment difficult. Attempting to translate the format into gaming, where speed in familiarizing players with the games is critical, has proved to be difficult. It would be desirable to be able to provide a gaming system that allows wagering in a Fantasy Football.

Published U.S. Patent Application Document No. 20020153656 (Maksymec) describes a wagering system in which the payment on either side of a “neutral” bet, or center point, increases as the amount of win or loss diverges from the center point. The system is particularly applicable to bets placed in legalized bookmaking establishments, which set a line for sports betting and permit bettors to wager on either side of the line. In a preferred embodiment, the amount of win or loss increases arithmetically with the departure of the final result from the center point. The system also includes the potential for placing caps (maximums) on the win/loss multiples, and providing cushions (i.e., deviations proximate to the center point) before which the increased wins and/or losses commence.

U.S. Pat. No. 8,177,644 (Anderson) discloses a gaming system and method of conducting a wagering game having a fantasy-sports feature on a gaming system. A wager is received from a user to play the wagering game. A roster having one or more player is created, via user selection. A projected team score and an actual team score for the created roster are determined. A ratio is calculated for the actual team score to the projected team score. An award is provided to the user if the calculated ratio meets a predetermined criterion.

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines.

In recent years, fantasy gaming, and particularly fantasy-sports gaming has become increasingly popular. Because of the continual need to develop new wagering games and gaming features to generate player appeal and excitement, it would be desirable to incorporate fantasy gaming into various wagering games to satisfy the demands of players and operators.

### SUMMARY OF THE INVENTION

A method of executing and system for a wagering event and resolving a wager includes steps of:
providing a processor having a memory in which is stored a list of game players consisting essentially of game players within a field of a single sport;
the processor configured to provide at least one first set of multiple game players, each game player in the set provided with a salary value;
the processor allowing a salary cap to each event player for use in selecting one list for the event player in the wagering event;
the processor accepting a wager from the event player on one list of game players selected by input of the player to the processor from set of multiple game players lists,
the total number of game players selected in the one list limited solely by exhaustion of the salary cap by totaling salary values for all event players selected by input of the event player, independent of numbers of total game players selected;
the wager based on an outcome within a predetermined period of time of either that a) at least total game points are scored during that predetermined period of time by totaling points scored by all game players in the one list as compared to either a fixed number of total game points or total game points that are scored during that predetermined period of time by all game players on an at least second list of game players having a salary cap at least equal to the salary cap of total players in the one list or different total number of game players having a salary cap at least equal to the salary cap of total players in the one list;
the wager resolved by determination of odds against a paytable of whether total game points from the one list exceed total game points scored by the at least second list or exceed the fixed number of game points;
at the conclusion of the predefined time frame, information regarding total game points scored by list one and the total game points scored by the at least second list is received into the memory;
the processor comparing the information regarding total points scored by list one and the total game points scored by the at least second list;
resolving the wager from the player against a paytable on a basis of an outcome that total game points scored by list one either exceeding the fixed number of game points or exceeds the total points scored by the at least second list; and
the wager being resolved as a win for the event player when the total points scored by list one at least equals the total points scored by the at least second list.

### BRIEF DESCRIPTION OF THE FIGURES

FIG. 1A is a perspective view of a free standing gaming machine embodying the present invention;

FIG. 1B is a perspective view of a handheld gaming machine embodying the present invention;

FIG. 2 is a block diagram of a control system suitable for operating the gaming machines of FIGS. 1A and 1B;

FIG. 3 is a flow diagram method for conducting a wagering game having a fantasy-sports feature, according to one embodiment of the present invention.

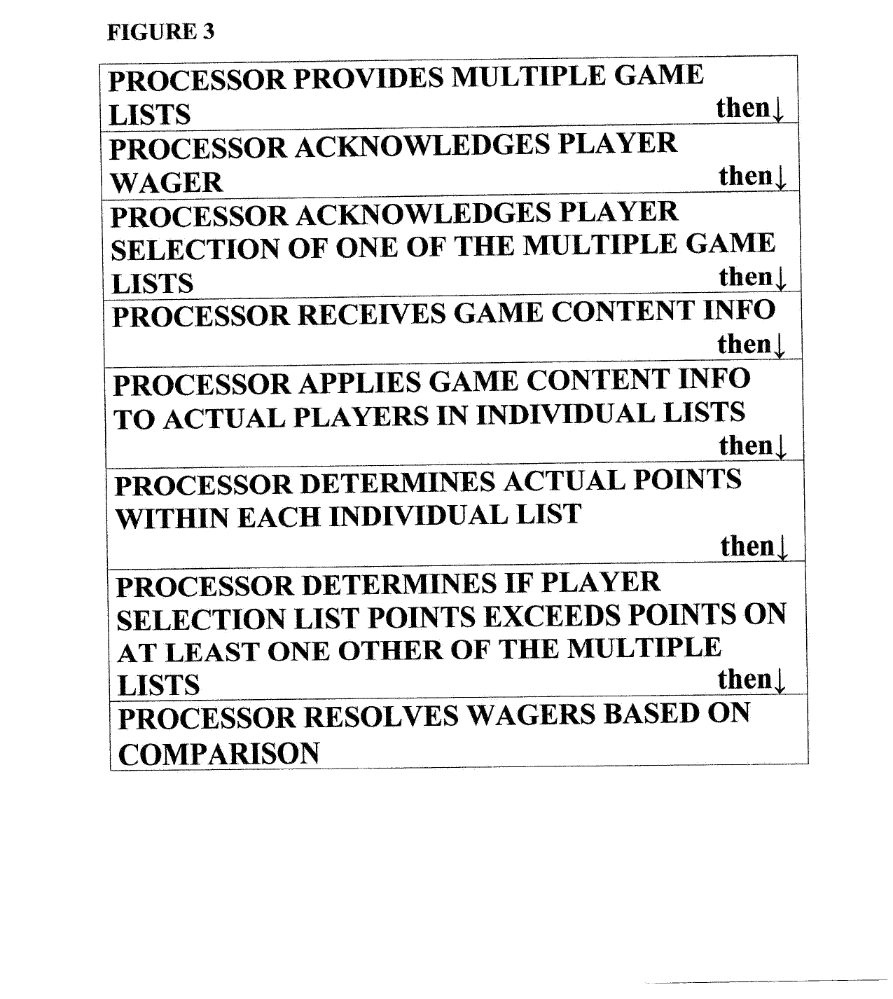

FIG. 4 is a representation of a ticket issued by a kiosk on a wagering event in accordance with the present technology.

FIG. 5 is a representation of a paytable and an alternative ticket issued on-line or at a kiosk on a wagering event in accordance with the present technology.

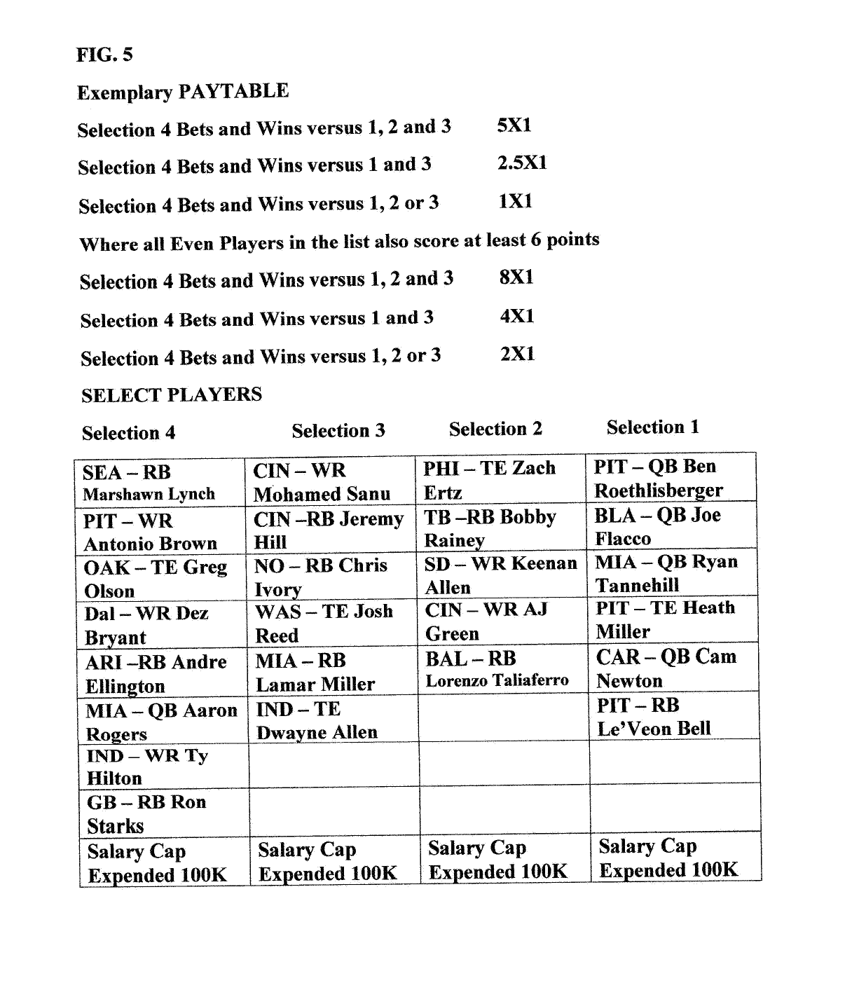

### DETAILED DESCRIPTION OF THE INVENTION

A method of executing and system for a wagering event and resolving a wager includes steps of:
providing a processor having a memory in which is stored a list of game players consisting essentially of game players within a field of a single sport;
the processor configured to provide at least one first set of multiple game players, each game player in the set provided with a salary value;
the processor allowing a salary cap to each event player for use in selecting one list for the event player in the wagering event;
the processor accepting a wager from the event player on one list of game players selected by input of the player to the processor from set of multiple game players lists,
the total number of game players selected in the one list limited solely by exhaustion of the salary cap by totaling salary values for all event players selected by input of the event player, independent of numbers of total game players selected;
the wager based on an outcome within a predetermined period of time of either that a) at least total game points are scored during that predetermined period of time by totaling points scored by all game players in the one list as compared to either a fixed number of total game points or total game points that are scored during that predetermined period of time by all game players on an at least second list of game players having a salary cap at least equal to the salary cap of total players in the one list or different total number of game players having a salary cap at least equal to the salary cap of total players in the one list;
the wager resolved by determination of odds against a paytable of whether total game points from the one list exceed total game points scored by the at least second list or exceed the fixed number of game points;
at the conclusion of the predefined time frame, information regarding total game points scored by list one and the total game points scored by the at least second list is received into the memory;
the processor comparing the information regarding total points scored by list one and the total game points scored by the at least second list;
resolving the wager from the player against a paytable on a basis of an outcome that total game points scored by list one either exceeding the fixed number of game points or exceeds the total points scored by the at least second list; and
the wager being resolved as a win for the event player when the total points scored by list one at least equals the total points scored by the at least second list.

The at least second list may be provided by a second player through a separate player input device than the input device used by the first player to select a player list and place a wager, or be selected by the processor (and then selected by a second player on a same or different player input device) comprises at least two lists different from list one, and resolution of the waiver when total points scored by list one exceeds the total points scored by at least the at least second list.

The at least second list may include at least five lists different from list one, and resolution of the waiver when total points scored by list one exceeds the total points scored by each of at least four of the at least five lists is at least 1:1.

The at least second list may include at least two lists selected from a processor-provided list of from 2-10 differing lists, and resolution of the waiver when total points scored by list one exceeds the total points scored by each list that is player selected from the 2-10 lists is at least 1:1.

The event player may be offered a selection of exactly two lists from which to choose the one list, with a remaining list from the exactly two lists becoming the second list, or the event player is offered a selection from more than two lists from which to choose the one list, with the processor selecting a remaining list from the more than two lists to become the second list.

At least one of the first list or second list may be required to achieve a minimum number of total points for the event player to achieve a winning outcome on the wager.

A system for executing a wagering event and resolving a wager may include:
a processor having a memory in which is stored a list of game players consisting essentially of game players within a field of a single sport;
the processor configured to provide multiple lists of selections of a set of game players, each list having at least a number X of game players;
the processor being in communication an event player input component for inputting both a wager, and selecting one list selected from the multiple lists, the processor configured to identify the wager as based on an outcome within a predetermined period of time of either that a) total game points are scored during that predetermined period of time by all players on the one list as compared to total game points that are scored during that predetermined period of time by all players on an at least second list of game players having at least a number X of players;
the processor configured to resolve the wager by determination of odds against a paytable of whether total points from the one list exceed total points scored by the at least second list;
the processor further configured, at the conclusion of the predefined time frame, to receive information regarding total points scored by list one and the total points scored by the at least second list is received into the memory;
the processor configured to compare the information regarding total points scored by list one and the total points scored by the at least second list;
the processor configured to resolve the wager from the event player against a paytable on a basis of an outcome that total points scored by list one exceeds the total points scored by the at least second list; and
the processor configured to determine the wager as a win and resolve the wager as a win for the event player when the total points scored by list one at least equals the total points scored by the at least second list.

The system may have the processor in communication with a printer/scanner that prints a ticket identifying the amount of the ager and list one and at least list two, and then scan the ticket to input the identified list one and list to, and the processor then resolving the wager on the ticket.

Alternative methods of executing a wagering event and resolving a wager described in copending applications of the inventor include steps of:
providing a processor having a memory in which is stored a list of X number of players consisting essentially of players within a field of a single sport;
the processor configured to provide and providing selections of a set of players having a number Y which is less than X, and the processor associating a Z number of total points associated with the field of the single sport;
the processor accepting a wager from a player on an outcome within a predetermined period of time of either that a) the Y number of players will score more than a total of Z number of points, or b) the Y number of players will score less than a total of Z number of points,
at the conclusion of the predefined time frame, information regarding a W total points scored collectively during the predefined time frame by the Y number of players is received into the memory;
the processor compares the information regarding the total points scored collectively during the predefined time frame by the Y number of players with the Z number of points identified in the wager;
resolving the wager from the player on a basis of an outcome of either that a) the Y number of players scoring W points scored more than or less than the Z number of points associated with the wager; and
the wager being resolved at no more than 1:1, at 1:1, or more than 1:1 when the wager is for the Y number of players to score more than Z number of points and W>Z, the wagering being a loss when W<Z; the wager being resolved at no more than 1:1, at 1:1, or more than 1:1 when the wager is for the Y number of players to score fewer than Z number of points and W<Z, the wagering being a loss when W>Z, and the wager being either a loss or a push when W=Z.
The number of points Z may be determined by processor selection from among the X number of players or by processor selection of a Y₁ number of players and W is determined as a number of total points scored by the Y₁ players at the end of the predetermined time period. There may or may not be a specific point target or an alternate lineup with X number of specific players to score Z points, but rather the processor may provide one or more line-ups with the event player (as opposed to the sports game player) selecting a lineup 1 to outscore lineup 2, or lineup 3, or lineup 4 (etc.) or alternatively selecting a lineup 1 against multiple ones (any of) from among lineups 2, 2, 4 etc. The numbering of the lineups is not significant, but is used as an arbitrary basis of description. From among 2, 3, 4, 5, 6 or even 10 lineups, the event player may select any one of the lineups to be the active lineup versus one or more (again selected by the event player) alternative processor generated lineups.
For example, there may be a list 1 of players and lists numbered 2-25 of players. If the event player chooses list arbitrarily named as number 1, that list 1 must outscore any one of or a percentage of lists against which list 1 has been selected to play. If only list 2 is in play against list 1, that list is the only list (2) against which list 1 must provide more (or at least equal) points. If the event player chooses list 2, it must outscore list 1. A more likely scenario would be having lists 1, 2 and 3 (etc.), and if the event player chooses list 1, it must outscore 2 AND 3, etc. If a large number (e.g., Q) of lists is selected (e.g., 6 or more, typically up to 10 lists), there may be a paytable wherein even when fewer than Q lists score fewer points than active list 1, there may be payouts. For example, with 10 opposing lists, a paytable may be provide, by way of example, as:

| | Odds with List 1 > Points- |
|---|---|
| Player List 1 versus 10 Opposed Lists | versus # Lists |
| 10 Lists with Lower Score Total | 100:1 |
| 9 Lists with Lower Score Total | 30:1 |
| 8 Lists with Lower Score Total | 20:1 |
| 7 Lists with Lower Score Total | 4:1 |
| 6 Lists with Lower Score Total | 1:1 |
| 0-5 Lists with Lower Score Total | 0 |

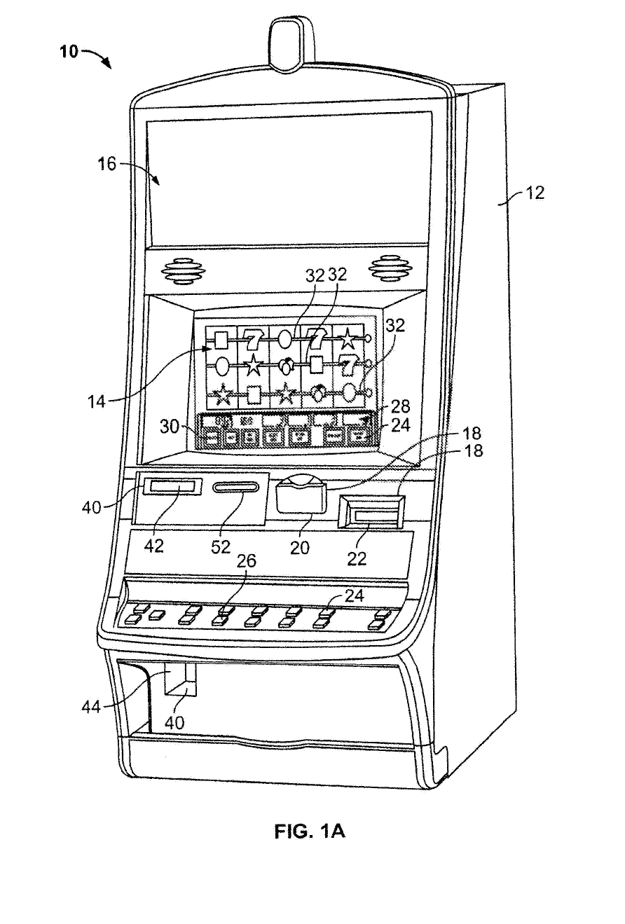

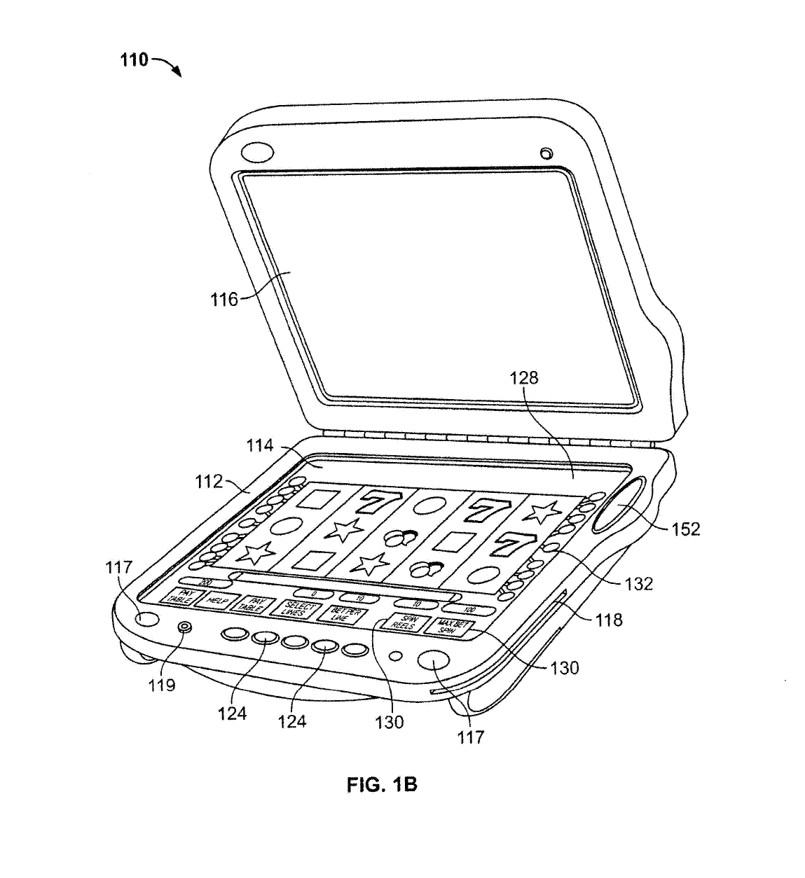

Referring to FIG. 1A, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine similar to those configured to play a video casino game, such as slots, keno, poker, blackjack, roulette, etc.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits that are inserted by a player. The value input device 18 may include a coin acceptor 20 for receiving coin currency (see FIG. 1a). Alternatively, or in addition, the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an alternative method of input. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1a, or may be located outboard of the housing 12 and connected to the housing 12 via a variety of different wired or wireless connection methods. Thus, the gaming machine 10 comprises these components whether housed in the housing 12, or outboard of the housing 12 and connected remotely.

The operation of the basic wagering game is displayed to the player on the primary display 14. The primary display 14 can also display the bonus game associated with the basic wagering game. The primary display 14 may take the form of a cathode ray tube (CRT), a high resolution LCD, a plasma display, an LED, or any other type of display suitable for use in the gaming machine 10. As shown, the primary display 14 includes the touch screen 28 overlaying the entire display (or a portion thereof) to allow players to make game-related selections. Alternatively, the primary display 14 of the gaming machine 10 may include a number of mechanical reels to display the outcome in visual association with at least one payline 32. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of symbols arranged in an array, and includes at least one payline 32 that indicates one or more outcomes of the basic game. Such outcomes are randomly selected in response to the wagering input by the player. At least one of the plurality of randomly-selected outcomes may be a start-bonus outcome, which can include any variations of symbols or symbol combinations triggering a bonus game.

In some embodiments, the gaming machine 10 may also include a player information reader 52 that allows for identification of a player by reading a card with information indicating his or her true identity. The player information reader 52 is shown in FIG. 1a as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

Depicted in FIG. 1b is a handheld or mobile gaming machine 110. Like the free standing gaming machine 10, the handheld gaming machine 110 is preferably an electronic gaming machine configured to play a video casino game such as, but not limited to, blackjack, slots, keno, poker, blackjack, and roulette. The handheld gaming machine 110 comprises a housing or casing 112 and includes input devices, including a value input device 118 and a player input device 124. For output the handheld gaming machine 110 includes, but is not limited to, a primary display 114, a secondary display 116, one or more speakers 117, one or more player-accessible ports 119 (e.g., an audio output jack for headphones, a video headset jack, etc.), and other conventional I/O devices and ports, which may or may not be player-accessible. In the embodiment depicted in FIG. 1b, the handheld gaming machine 110 comprises a secondary display 116 that is rotatable relative to the primary display 114. The optional secondary display 116 may be fixed, movable, and/or detachable/attachable relative to the primary display 114. Either the primary display 114 and/or secondary display 116 may be configured to display any aspect of a non-wagering game, wagering game, secondary games, bonus games, progressive wagering games, group games, shared-experience games or events, game events, game outcomes, scrolling information, text messaging, emails, alerts or announcements, broadcast information, subscription information, and handheld gaming machine status.

The player-accessible value input device 118 may comprise, for example, a slot located on the front, side, or top of the casing 112 configured to receive credit from a stored-value card (e.g., casino card, smart card, debit card, credit card, etc.) inserted by a player. In another aspect, the player-accessible value input device 118 may comprise a sensor (e.g., an RF sensor) configured to sense a signal (e.g., an RF signal) output by a transmitter (e.g., an RF transmitter) carried by a player. The player-accessible value input device 118 may also or alternatively include a ticket reader, or barcode scanner, for reading information stored on a credit ticket, a card, or other tangible portable credit or funds storage device. The credit ticket or card may also authorize access to a central account, which can transfer money to the handheld gaming machine 110.

Still other player-accessible value input devices 118 may require the use of touch keys 130 on the touch-screen display (e.g., primary display 114 and/or secondary display 116) or player input devices 124. Upon entry of player identification information and, preferably, secondary authorization information (e.g., a password, PIN number, stored value card number, predefined key sequences, etc.), the player may be permitted to access a player's account. As one potential optional security feature, the handheld gaming machine 110 may be configured to permit a player to only access an account the player has specifically set up for the handheld gaming machine 110. Other conventional security features may also be utilized to, for example, prevent unauthorized access to a player's account, to minimize an impact of any unauthorized access to a player's account, or to prevent unauthorized access to any personal information or funds temporarily stored on the handheld gaming machine 110.

The player-accessible value input device 118 may itself comprise or utilize a biometric player information reader which permits the player to access available funds on a player's account, either alone or in combination with another of the aforementioned player-accessible value input devices 118. In an embodiment wherein the player-accessible value input device 118 comprises a biometric player information reader, transactions such as an input of value to the handheld device, a transfer of value from one player account or source to an account associated with the handheld gaming machine 110, or the execution of another transaction, for example, could all be authorized by a biometric reading, which could comprise a plurality of biometric readings, from the biometric device.

Alternatively, to enhance security, a transaction may be optionally enabled only by a two-step process in which a secondary source confirms the identity indicated by a primary source. For example, a player-accessible value input device 118 comprising a biometric player information reader may require a confirmatory entry from another biometric player information reader 152, or from another source, such as a credit card, debit card, player ID card, fob key, PIN number, password, hotel room key, etc. Thus, a transaction may be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 118 may be provided remotely from the handheld gaming machine 110.

The player input device 124 comprises a plurality of push buttons on a button panel for operating the handheld gaming machine 110. In addition, or alternatively, the player input device 124 may comprise a touch screen 128 mounted to a primary display 114 and/or secondary display 116. In one aspect, the touch screen 128 is matched to a display screen having one or more selectable touch keys 130 selectable by a user's touching of the associated area of the screen using a finger or a tool, such as a stylus pointer. A player enables a desired function either by touching the touch screen 128 at an appropriate touch key 130 or by pressing an appropriate push button 126 on the button panel. The touch keys 130 may be used to implement the same functions as push buttons 126. Alternatively, the push buttons may provide inputs for one aspect of the operating the game, while the touch keys 130 may allow for input needed for another aspect of the game. The various components of the handheld gaming machine 110 may be connected directly to, or contained within, the casing 112, as seen in FIG. 1b, or may be located outboard of the casing 112 and connected to the casing 112 via a variety of hardwired (tethered) or wireless connection methods. Thus, the handheld gaming machine 110 may comprise a single unit or a plurality of interconnected parts (e.g., wireless connections) which may be arranged to suit a player's preferences. The operation of the basic wagering game on the handheld gaming machine 110 is displayed to the player on the primary display 114. The primary display 114 can also display the bonus game associated with the basic wagering game. The primary display 114 preferably takes the form of a high resolution LCD, a plasma display, an LED, or any other type of display suitable for use in the handheld gaming machine 110. The size of the primary display 114 may vary from, for example, about a 2-3 inch′ display to a 15-inch or 17-inch′ display. In at least some aspects, the primary display 114 is a 7-inch-10-inch display. As the weight of and/or power requirements of such displays decreases with improvements in technology, it is envisaged that the size of the primary display may be increased. Optionally, coatings or removable films or sheets may be applied to the display to provide desired characteristics (e.g., anti-scratch, anti-glare, bacterially-resistant and anti-microbial films, etc.). In at least some embodiments, the primary display 114 and/or secondary display 116 may have a 16:9 aspect ratio or other aspect ratio (e.g., 4:3). The primary display 114 and/or secondary display 116 may also each have different resolutions, different color schemes, and different aspect ratios.

As with the free standing gaming machine 10, a player begins play of the basic wagering game on the handheld gaming machine 110 by making a wager (e.g., via the value input device 18 or an assignment of credits stored on the handheld gaming machine via the touch screen keys 130, player input device 124, or buttons 126) on the handheld gaming machine 110. In at least some aspects, the basic game may comprise a plurality of symbols arranged in an array, and includes at least one payline 132 that indicates one or more outcomes of the basic game. Such outcomes are randomly selected in response to the wagering input by the player. At least one of the plurality of randomly selected outcomes may be a start-bonus outcome, which can include any variations of symbols or symbol combinations triggering a bonus game.

In some embodiments, the player-accessible value input device 118 of the handheld gaming machine 110 may double as a player information reader 152 that allows for identification of a player by reading a card with information indicating the player's identity (e.g., reading a player's credit card, player ID card, smart card, etc.). The player information reader 152 may alternatively or also comprise a bar code scanner, RFID transceiver or computer readable storage medium interface. In one presently preferred aspect, the player information reader 152, shown by way of example in FIG. 1b, comprises a biometric sensing device.

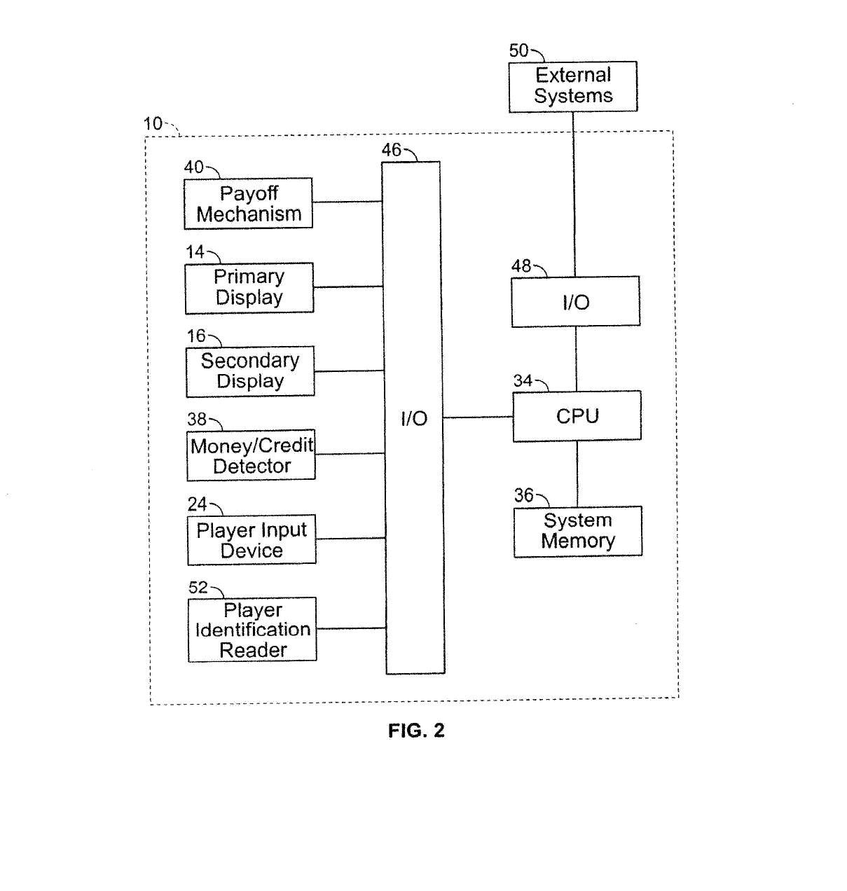

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1a, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36. The controller 34 may reside partially or entirely inside or outside of the machine 10. The control system for a handheld gaming machine 110 may be similar to the control system for the free standing gaming machine 10 except that the functionality of the respective on-board controllers may vary.

The gaming machines 10, 110 may communicate with external systems 50 (in a wired or wireless manner) such that each machine operates as a “thin client,” having relatively less functionality, a “thick client,” having relatively more functionality, or through any range of functionality therebetween (e.g., a “rich client”). As a generally “thin client,” the gaming machine may operate primarily as a display device to display the results of gaming outcomes processed externally, for example, on a server as part of the external systems 50. In this “thin client” configuration, the server executes game code and determines game outcomes (e.g., with a random number generator), while the controller 34 on board the gaming machine processes display information to be displayed on the display(s) of the machine. In an alternative “rich client” configuration, the server determines game outcomes, while the controller 34 on board the gaming machine executes game code and processes display information to be displayed on the display(s) of the machines. In yet another alternative “thick client” configuration, the controller 34 on board the gaming machine 110 executes game code, determines game outcomes, and processes display information to be displayed on the display(s) of the machine. Numerous alternative configurations are possible such that the aforementioned and other functions may be performed onboard or external to the gaming machine as may be necessary for particular applications. It should be understood that the gaming machines 10, 110 may take on a wide variety of forms such as a free standing machine, a portable or handheld device primarily used for gaming, a mobile telecommunications device such as a mobile telephone or personal daily assistant (PDA), a counter top or bar top gaming machine, or other personal electronic device such as a portable television, MP3 player, entertainment device, etc. A particularly useful structure for enabling practice of the present technology is a kiosk format, with the player placing wagers, making selections and even receiving printout tickets identifying the outcome content of the wager, the amount of the wager, and even the player name. Especially with higher payout amounts (e.g., in excess of $1.000.00), personal identification confirming the identity of the player is highly desirable, even with biometrics embedded in the printed receipt, by imagery, bar code, QR code or other machine-readable technology that can assure precise and correct identification of the player. Anti-forgery technology should be incorporated into the material of the ticket. Embedded threads, complex paper (or polymeric) base materials, embedded wire/filament with readable (e.g., magnetic or optical code) security information, serial numbers, or other code or encryption should be embedded in the ticket. The kiosk may have capability of printing tickets with text showing (in one format, font, color, tone or density) the total selection of available players (or remaining players NOT selected) and the player selected players will have their text in a separate format, font, color, tone or density) to stand out from non-selected available players.

In the systems useful in practices of the present technologies, examples of the above gaming machines 10, 110 may be used to interact with a wagering game having a fantasy-gaming feature. The fantasy-gaming feature may relate to, for example, a sporting event or any other event or activity having statistical information that can be tracked. In embodiments in which the fantasy-gaming feature relates to sporting events, various types of game play and wagering options may be provided. For example, a user may be prompted to select particular players, positions, teams, etc. or to select from particular divisions, conferences, leagues, etc. In these embodiments, the fantasy-gaming feature can monitor one or more tracked statistics and determine a resultant winner or winners as will be described in greater detail below.

The tracked statistics are utilized to resolve the user's wager and may be tracked over a period of time. For example, the statistics used to resolve the user's wager may be tracked over a period of seconds, minutes, hours, days, weeks, months, or even years. The statistics may be tracked over a single play or group of plays, or over one or more innings, quarters, periods, halves, or races. Additionally or alternatively, the statistics may be tracked over a single game or group of games, a season or portion(s) thereof, or any time period desired by the operator.

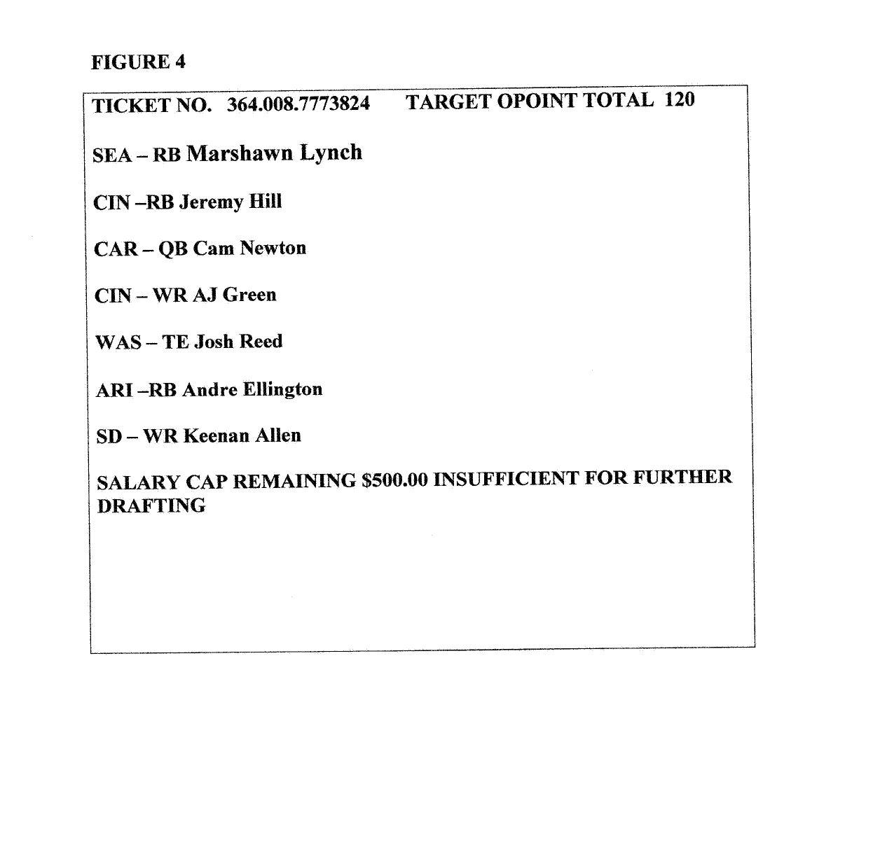

The printer may be configured to print wager tickets identifying wager content as represented by identification of at least players consisting of the X number of players, the Y number of players and the Z number of players, with printing content distinguishing between the players within the Z number of players and the Y number of players and the X number of players. The printer preferably is able to print with multiple fonts on the same ticket, multiple colors, multiple shades and densities. As shown in FIG. 4, a sample gaming ticket is shown with 50 (RB) running backs and 50 (RC) receivers for the total number of 100 possible players as the X number of players. Note that 25 players (the Y number of players) are in a different density fonts to distinguish between the X players and the Y players. The Z players are identified by the “Player Selected” notation. These may be in different colors for further distinction. The printers are part of the wagering system which may include
a) a housing for electronic components;
b) a computer;
c) a display screen;
d) a memory;
e) an information link to current information on active players that can be used if providing the X number of players;
f) an information link to official football (or other sport) results inclusive of all the players within the X number of players;
g) random number generator; and
h) player input controls allowing identification of the Z number of players.

The wagering system may have a printer attached to the housing and in communication with the computer, the printer being configured to print wager tickets identifying wager content as represented by identification of at least players consisting of the Z number of players.

The above wagering games may also include a local-area and/or wide-area progressive jackpot. A progressive jackpot may be earned for achieving a predetermined threshold or may be awarded when a user finishes ranked in a corresponding finish place for a particular event or over the course of a season or tournament.

The system may incorporate private communication devices that can keep users aware of the status of their wagers and individual and collective ones of the Z players. Typical sports betting arenas could have a screen dedicated to, or intermittently displaying present results of the sports events and point scoring that is integral to the wagering event of the present technology. To control the math of the system, individual players may be selection-statistically weighted. That is, if a player with an excellent scoring record is playing a next game against a team with a weak defense, rather than making selection of that player equally probable with selection of a statistically weaker player against a strong defense, the random number generation system may be weighted in favor of a higher rate of selection of the weaker player. Thus, with 100 players and 100,000 possible pseudo random selection events (if equally divided, each player would be provided with 1000 selection events), the stronger player against a weak defense might be provided with only 300 selection events and the weaker player against the strong defense might be provided with 1700 selection events.

The game method and gaming system are further described below. A method of executing a wagering event and resolving a wager may include steps of:
providing a processor having a memory in which is stored a list of game players consisting essentially of game players within a field of a single sport;
the processor configured to provide and providing multiple lists of selections of a set of game players, each list having at least a number X selected from a finite pool of game players, such as all players in normal scoring positions for football (e.g., quarterbacks, running backs, receivers (possibly differentiation among tight ends, wide receivers, and the like), and even kick return specialists or cornerbacks and safeties)) or other sport. Where game players with more limited opportunities to score are selected, they may be awarded multiples of actual scoring capabilities such as two or three times their actual score;
the processor accepting a wager from an event player on one list selected from the multiple lists, the wager based on an outcome within a predetermined period of time of either that a) total game points are scored during that predetermined period of time by all game players on the one list as compared to either a fixed number of total game points or total game points that are scored during that predetermined period of time by all game players on an at least second list of game players having at least a number X of game players;
the wager resolved by determination of odds against a paytable of whether total points from the one list exceed total points scored by the at least second list;
at the conclusion of the predefined time frame, information regarding total points scored by list one and the total points scored by the at least second list is received into the memory;
the processor comparing the information regarding total points scored by list one and the total points scored by the at least second list;
resolving the wager from the player against a paytable on a basis of an outcome that total points scored by list one exceeds the total points scored by the at least second list; and
the wager being resolved as a win for the event player when the total points scored by list one at least equals the total points scored by the at least second list. The wager may be resolved and payments made on the basis of paytables with odds varying by amounts enabled to provide a house advantage, as from 1:2 to 100 s:1, depending on the complexity and number of players and lists used.

The method may have the at least second list comprises at least two lists different from list one, and resolution of the waiver when total points scored by list one exceeds the total points scored by each of the at least two lists exceeds 1:1, or wherein the at least second list comprises at least five lists different from list one, and resolution of the waiver when total points scored by list one exceeds the total points scored by each of at least four of the at least five lists is at least 1:1.

The at least second list may be at least two lists selected from a processor-provided list of from 2-10 differing lists, and resolution of the waiver when total points scored by list one exceeds the total points scored by each list that is player selected from the 2-10 lists is at least 1:1. The method may be practiced wherein the event player is offered a selection of exactly two lists from which to choose the one list, with a remaining list from the exactly two lists becoming the second list, or wherein the event player is offered a selection from more than two lists from which to choose the one list, with the processor selecting a remaining list from the more than two lists to become the second list.

The method may be practiced wherein at least one of the first list or second list must achieve a minimum absolute number of total points for the event player to achieve a winning outcome on the wager, or wherein at least one of the first list or second list must achieve a minimum absolute number of total points and/or exceed a second player's list (e.g., an opposing player of a processor created list) for the event player to achieve a winning outcome on the wager.

A system for executing a wagering event and resolving a wager by steps including:
a processor having a memory in which is stored a list of game players consisting essentially of game players within a field of a single sport;
the processor configured to provide multiple lists of selections of a set of game players, each list having at least a number X of game players;
the processor being in communication an event player input component for inputting both a wager, and selecting one list selected from the multiple lists, the processor configured to identify the wager as based on an outcome within a predetermined period of time of either that a) total game points are scored during that predetermined period of time by all players on the one list as compared to total game points that are scored during that predetermined period of time by all players on an at least second list of game players having at least a number X of players;
the processor configured to resolve the wager by determination of odds against a paytable of whether total points from the one list exceed total points scored by the at least second list;
the processor further configured, at the conclusion of the predefined time frame, to receive information regarding total points scored by list one and the total points scored by the at least second list is received into the memory;
the processor configured to compare the information regarding total points scored by list one and the total points scored by the at least second list;
the processor configured to resolve the wager from the event player against a paytable on a basis of an outcome that total points scored by list one exceeds the total points scored by the at least second list; and
the processor configured to determine the wager as a win and resolve the wager as a win for the event player when the total points scored by list one at least equals the total points scored by the at least second list.

The processor is in communication with a printer/scanner that prints a ticket identifying the amount of the ager and list one and at least list two, and then scan the ticket to input the identified list one and list to, and the processor then resolving the wager on the ticket.

These and other supporting or ancillary technologies may be added and used within the underlying technology of the present invention.

What is claimed:

1. A method of executing a wagering event and resolving a wager comprising steps of:
providing a processor having a memory in which is stored a list of game players consisting essentially of game players within a field of a single sport;
the processor configured to provide at least one first set of multiple game players, each game player in the set provided with a salary value;
the processor allowing a salary cap to each event player for use in selecting one list for the event player in the wagering event;
the processor accepting a wager from the event player on one list of game players selected by input of the player to the processor from set of multiple game players lists,
the total number of game players selected in the one list limited solely by exhaustion of the salary cap by totaling salary values for all event players selected by input of the event player, independent of numbers of total game players selected;
the wager based on an outcome within a predetermined period of time of either that a) at least total game points are scored during that predetermined period of time by totaling points scored by all game players in the one list as compared to either a fixed number of total game points or total game points that are scored during that predetermined period of time by all game players on an at least second list of game players having a salary cap at least equal to the salary cap of total players in the one list or different total number of game players having a salary cap at least equal to the salary cap of total players in the one list;
the wager resolved by determination of odds against a paytable of whether total game points from the one list exceed total game points scored by the at least second list or exceed the fixed number of game points;
at the conclusion of the predefined time frame, information regarding total game points scored by list one and the total game points scored by the at least second list is received into the memory;
the processor comparing the information regarding total points scored by list one and the total game points scored by the at least second list;
resolving the wager from the player against a paytable on a basis of an outcome that total game points scored by list one either exceeding the fixed number of game points or exceeds the total points scored by the at least second list; and
the wager being resolved as a win for the event player when the total points scored by list one at least equals the total points scored by the at least second list.

2. The method of claim 1 wherein the at least second list is provided by a second player or selected by the processor comprises at least two lists different from list one, and resolution of the waiver when total points scored by list one exceeds the total points scored by at least the at least second list.

3. The method of claim 1 wherein the at least second list comprises at least five lists different from list one, and resolution of the waiver when total points scored by list one exceeds the total points scored by each of at least four of the at least five lists is at least 1:1.

4. The method of claim 1 wherein the at least second list comprises at least two lists selected from a processor-provided list of from 2-10 differing lists, and resolution of the waiver when total points scored by list one exceeds the total points scored by each list that is player selected from the 2-10 lists is at least 1:1.

5. The method of claim 1 wherein the event player is offered a selection of exactly two lists from which to choose the one list, with a remaining list from the exactly two lists becoming the second list.

6. The method of claim 1 wherein the event player is offered a selection from more than two lists from which to choose the one list, with the processor selecting a remaining list from the more than two lists to become the second list.

7. The method of claim 1 wherein at least one of the first list or second list must achieve a minimum number of total points for the event player to achieve a winning outcome on the wager.

8. The method of claim 6 wherein at least one of the first list or second list must achieve a minimum number of total points for the event player to achieve a winning outcome on the wager.

9. A system for executing a wagering event and resolving a wager comprising:
a processor having a memory in which is stored a list of game players consisting essentially of game players within a field of a single sport;
the processor configured to provide multiple lists of selections of a set of game players, each list having at least a number X of game players;
the processor being in communication an event player input component for inputting both a wager, and selecting one list selected from the multiple lists, the processor configured to identify the wager as based on an outcome within a predetermined period of time of either that a) total game points are scored during that predetermined period of time by all players on the one list as compared to total game points that are scored during that predetermined period of time by all players on an at least second list of game players having at least a number X of players;
the processor configured to resolve the wager by determination of odds against a paytable of whether total points from the one list exceed total points scored by the at least second list;
the processor further configured, at the conclusion of the predefined time frame, to receive information regarding total points scored by list one and the total points scored by the at least second list is received into the memory;
the processor configured to compare the information regarding total points scored by list one and the total points scored by the at least second list;
the processor configured to resolve the wager from the event player against a paytable on a basis of an outcome that total points scored by list one exceeds the total points scored by the at least second list; and
the processor configured to determine the wager as a win and resolve the wager as a win for the event player when the total points scored by list one at least equals the total points scored by the at least second list.

10. The system of claim 9 wherein the processor is in communication with a printer/scanner that prints a ticket identifying the amount of the wager and list one and at least list two, and then scan the ticket to input the identified list one and list to, and the processor then resolving the wager on the ticket.
